(19) United States
(12) Patent Application Publication
(10) Pub. No.: US 2004/0221951 A1
(43) Pub. Date: Nov. 11, 2004

(54) Method for bonding an integrated circuit device to a glass substrate

(76) Inventors: Ta-Ko Chuang, Taichung (TW); Sakae Tanaka, Taoyuan Hsien (TW)

Correspondence Address: Richard P. Berg, Esq., c/o LADAS & PARRY, Suite 2100, 5670 Wilshire Boulevard, Los Angeles, CA, 90036-5679, US

(21) Appl. No.: 10/798,235

(22) Filed: Mar. 10, 2004

Related U.S. Application Data
(63) Continuation-in-part of application No. 10/028,880, filed on Dec. 20, 2001, now abandoned.

(30) Foreign Application Priority Data
Jul. 26, 2001 (TW) 90118342

(51) Int. Cl. B32B 31/00

(52) U.S. Cl. 156/272.8; 156/155

(57) ABSTRACT

A method for bonding an integrated circuit device to a glass substrate is provided. The method comprises the following steps. First, a melting device is provided, and the melting device melts a predetermined portion of the glass substrate. Then, the integrated circuit device is bonded to the glass substrate without suffering from damages by sharp edges of the glass substrate.

The present application is a continuation-in-part of U.S. application Ser. No. 10/028,880, filed Dec. 20, 2001, now pending.

### BACKGROUND OF THE INVENTION

1. Field of the Invention

The invention relates to a method for bonding an integrated circuit device to a glass substrate; in particular, the invention relates to a method that can bond the integrated circuit device to the glass substrate without suffering from damages by sharp edges of the glass substrate.

2. Description of the Related Art

Referring to FIG. 1a, FIG. 1b, FIG. 1c, FIG. 1d and FIG. 1e, a conventional method for bonding an integrated circuit device to a glass substrate, comprises the following steps. After the glass substrate 10 is scribed and broken, as shown in step S1 of FIG. 1a, it is ground at its edges by a grinding device 11, as shown in FIG. 1b and in step S2 of FIG. 1a. Thus, a beveled angle 101 is formed at the edges, as shown in FIG. 1c. Then, the ground substrate glass 10 is cleaned by a cleaning device 12, as shown in FIG. 1c and in step S3 of FIG. 1a. Finally, the integrated circuit device 13 is bonded to the glass substrate 10, as shown in FIG. 1d and FIG. 1e and in step S4 of FIG. 1a. It is noted that the integrated circuit device 13 comprises a driver circuit 131 and a main board 133. The driver circuit 131 and the main board 133 are bonded to a circuit 14 on the glass substrate 10 via a connecting wire 132. The driver circuit 131 may be located on the main board 133, as shown in FIG. 1d, or located on the connecting wire 132, as shown in FIG. 1e. In summary, the connecting wire 132 of the integrated circuit device 13 is bonded to the circuit 14 of the glass substrate 10. In addition, the connecting wire 132 is bonded to the circuit 14, disposed on the glass substrate 10, via an adhesive 15 11 and plural conductive particles 16.

In the above step S2, grinding is used to improve the contact area between the integrated circuit device 13 and the glass substrate 10. As a result, the integrated circuit device 13 is not damaged by the sharp edges of the glass substrate 10.

The conventional method has the following disadvantages:

1. There is debris and dust produced when the grinding device grinds the glass substrate.

2. Post-bonding process is required, such as cleaning.

3. Referring to FIG. 1f, the glass substrate may be used as a liquid crystal display panel 10 that comprises two substrates 1, 2, seal 3 and liquid crystal 4 disposed between the substrates 1, 2. After the cleaning process, vapors may diffuse into the liquid crystal 4 through the seal 3 so as to damage the liquid crystal 4.

4. Since the process is troublesome, its throughput is low.

### SUMMARY OF THE INVENTION

In order to address the disadvantages of the aforementioned bonding method, the invention provides a method that can bond an integrated circuit device to a glass substrate in a shorter time.

Accordingly, the invention provides a method for bonding an integrated circuit device to a glass substrate. The method comprises the following steps. First, a melting device is provided, and the melting device melts a predetermined portion of the glass substrate. Then, the integrated circuit device is bonded to the glass substrate.

Furthermore, the melting device is a laser device.

In a preferred embodiment, a protecting circuit, connecting with an external circuit, is disposed on the glass substrate, and the melting device comprises a first laser device for eliminating the protecting circuit and a second laser device for eliminating the predetermined portion of the glass substrate.

In a preferred embodiment, the integrated circuit device comprises a driver circuit, a connecting wire, and a main board, and the connecting wire is in contact with the predetermined portion, melted by the melting device, of the glass substrate when the integrated circuit device is bonded to the glass substrate.

Furthermore, the connecting wire is bonded to the protecting circuit of the glass substrate via an adhesive and a plurality of conductive particles.

In a preferred embodiment, the predetermined portion of the glass substrate is located at the edges of the glass substrate.

In a preferred embodiment, the invention provides another method for bonding an integrated circuit device to a glass substrate. The method comprises the following steps. First, one portion of the integrated circuit device is bonded to a predetermined portion of the glass substrate so that a gap is formed between the other portion of the integrated circuit device and the glass substrate. Then, resin is introduced into the gap so that the resin covers the predetermined portion of the glass substrate.

Furthermore, the resin is cured by ultraviolet light.

### BRIEF DESCRIPTION OF THE DRAWINGS

The invention is hereinafter described in detail with reference to the accompanying drawings in which:

FIG. 1a is a schematic view depicting a conventional method for bonding an integrated circuit device to a glass substrate;

FIG. 1b is a schematic view depicting a step S2 as shown in FIG. 1a;

FIG. 1c is a schematic view depicting a step S3 as shown in FIG. 1a;

FIG. 1d and FIG. 1e are schematic views depicting a step S4 as shown in FIG. 1a;

FIG. 1f is a cross-section depicting a liquid crystal display panel;

FIG. 2a is a schematic view depicting a first embodiment of a method for bonding an integrated circuit device to a glass substrate, as disclosed in this invention;

FIG. 2b and FIG. 2c are schematic views depicting a step S12 as shown in FIG. 2a;

FIG. 2d and FIG. 2e are schematic views depicting a step S13 as shown in FIG. 2a;

FIG. 3a is a schematic view depicting another embodiment of a melting device as disclosed in the first embodiment;

FIG. 3b is a schematic view depicting the protecting circuit after melting;

FIG. 4a is a schematic view depicting a second embodiment of a method for bonding an integrated circuit device to a glass substrate, as disclosed in this invention;

FIG. 4b and FIG. 4d are schematic views depicting a step S22 as shown in FIG. 4a; and

FIG. 4c and FIG. 4e are schematic views depicting a step S23 as shown in FIG. 4a.

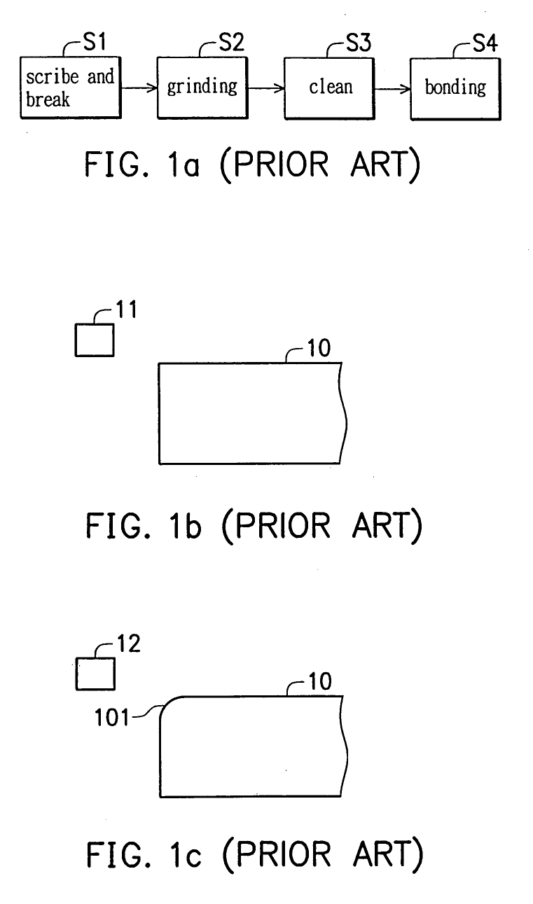

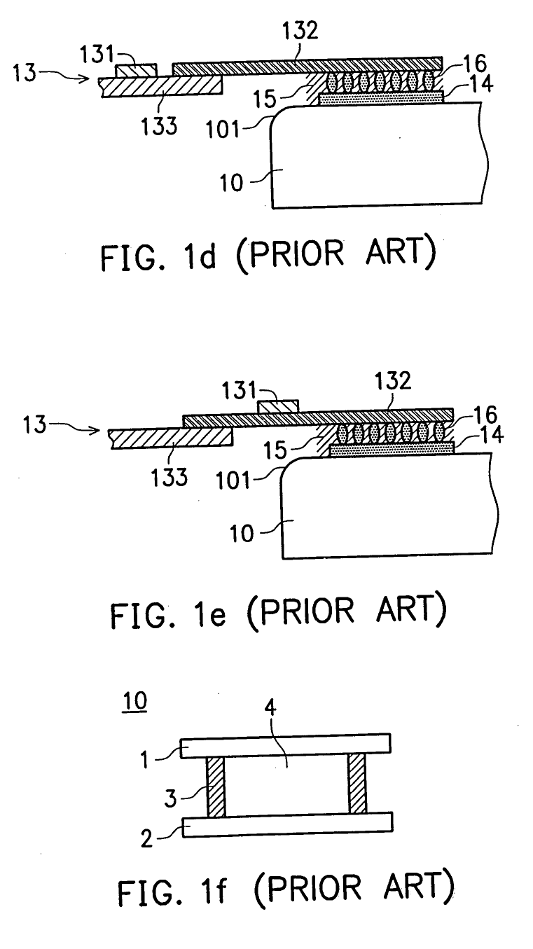

### DETAILED DESCRIPTION OF THE INVENTION

### FIRST EMBODIMENT

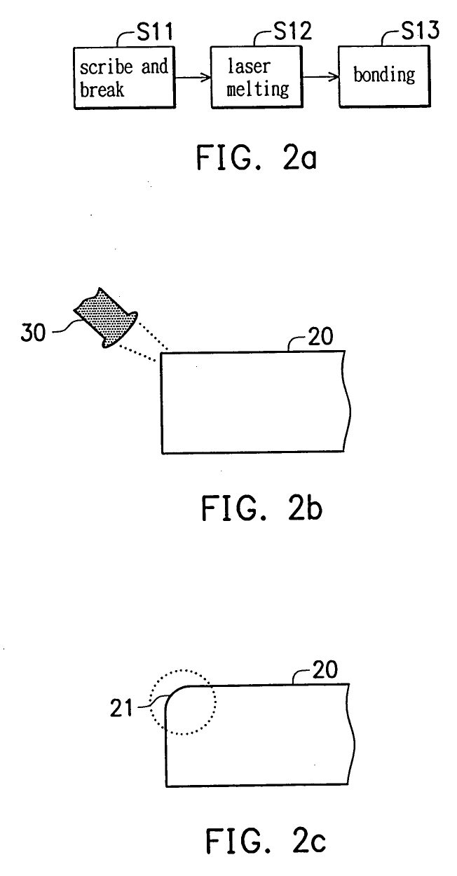

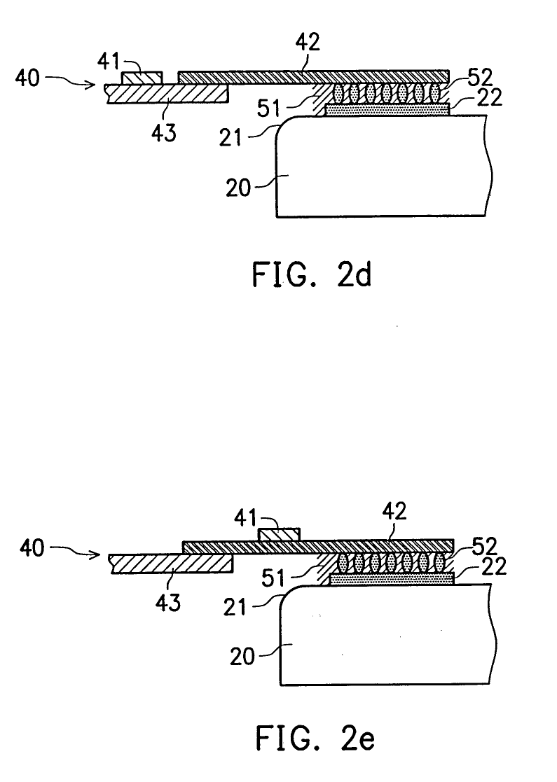

Referring to FIG. 2a, FIG. 2b, FIG. 2c, FIG. 2d and FIG. 2e a method for bonding an integrated circuit device to a glass substrate, of a first embodiment of this invention comprises the following steps. First, a glass substrate 20 is provided. After the glass substrate 10 is scribed and broken, as shown in step S11 of FIG. 2a, a melting device 30 is provided, and the melting device 30 melts a predetermined portion of the glass substrate 20, as shown in FIG. 2b and step S12 of FIG. 2a. It is noted that the predetermined portion of the glass substrate 20 is located at an edge of the glass substrate 20 in FIG. 2b. After performing the step S12, a round angle 21 is formed at the edge of the glass substrate 20, as shown in FIG. 2c. Then, an integrated circuit device 40 is provided, and is bonded to the glass substrate 20, as shown in FIG. 2d and FIG. 2e and step S13 of FIG. 2a.

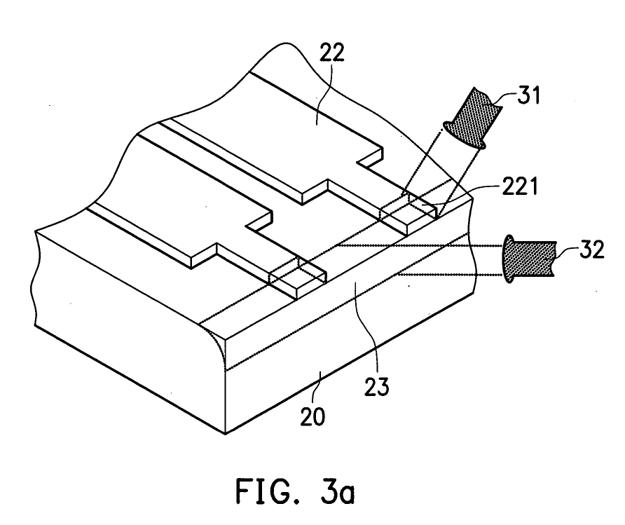

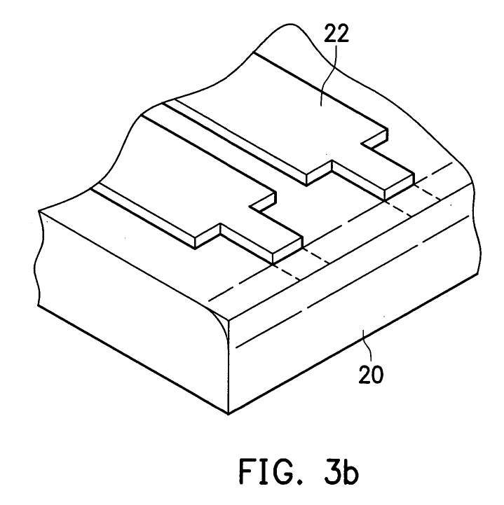

It is noted that only one integrated circuit device and portion of the edge of the glass substrate are shown in FIG. 2b, FIG. 2c, FIG. 2d and FIG. 2e. However, in practice, the melting device 30 may melt the whole one edge, as shown in FIG. 3a, or melt four edges on the glass substrate. In addition, a plurality of integrated circuit devices may be disposed on the glass substrate at a time.

As shown in FIG. 2b, the melting device 30 simply comprises a single laser device. However, the melting device may be shown as FIG. 3a because a protecting circuit 22, electrically connecting with an external circuit (not shown), is disposed on the glass substrate 20. Specifically, the melting device 30 may comprise a first laser device 31 for eliminating a predetermined portion 221 of the protecting circuit 22 and a second laser device 32 for eliminating the predetermined portion 23 of the glass substrate 20. In FIG. 2b, since the melting device 30 simply comprises a single laser device, depending on the eliminating object, the intensity of the laser device needs to be adjusted. In FIG. 3a, since the melting device 30 comprises two laser devices, depending on the eliminating object, the laser devices need to be switched. Specifically, the second laser device 32 serves to melt the predetermined portion (edge) 23 of the glass substrate 20, and not to cut the glass substrate 20. Thus, the second laser device 32 must emit laser light with long wavelength. In a situation that the protecting circuit 22 is located on the glass substrate 20, the laser light with long wavelength would be reflected by metallic electrodes constituting the protecting circuit 22. Thus, the edge 23 of the glass substrate 20 cannot be completely melted. As a result, the first laser device 31 serves to emit laser light with short wavelength to eliminate the portion connecting to the edge 23 of the glass substrate 20 of the protecting circuit 22, as shown in FIG. 3b. The edge 23 of the glass substrate 20 is then melted by the laser light with long wavelength emitted by the second laser device 32.

As shown in FIG. 2d and FIG. 2e, the integrated circuit device 40 comprises a driver circuit 41, a connecting wire 42, and a main board 43. The connecting wire 42 is in contact with the predetermined portion (smooth angle 21), melted by the melting device 30, of the glass substrate 20 when the integrated circuit device 40 is bonded to the glass substrate 20. In addition, like the conventional method, the connecting wire 42 is bonded to the protecting circuit 22 of the glass substrate 20 via an adhesive 51 and a plurality of conductive particles 52.

As stated above, in this embodiment, since the edge of the glass substrate is melted by laser, there is no debris and dust produced. Thus, no post-bonding process is required to prevent vapors diffusing into the substrate. As a result, the whole process time is reduced, and the throughput is enhanced.

### SECOND EMBODIMENT

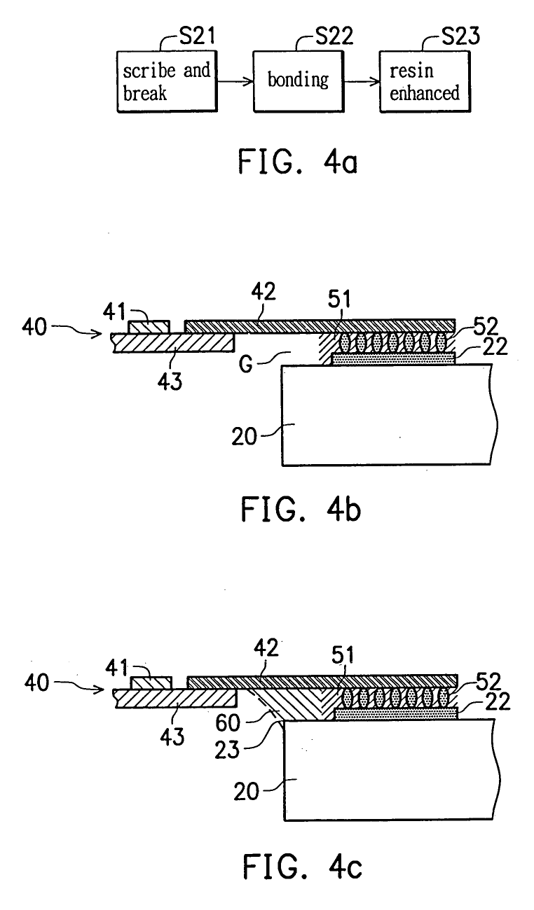

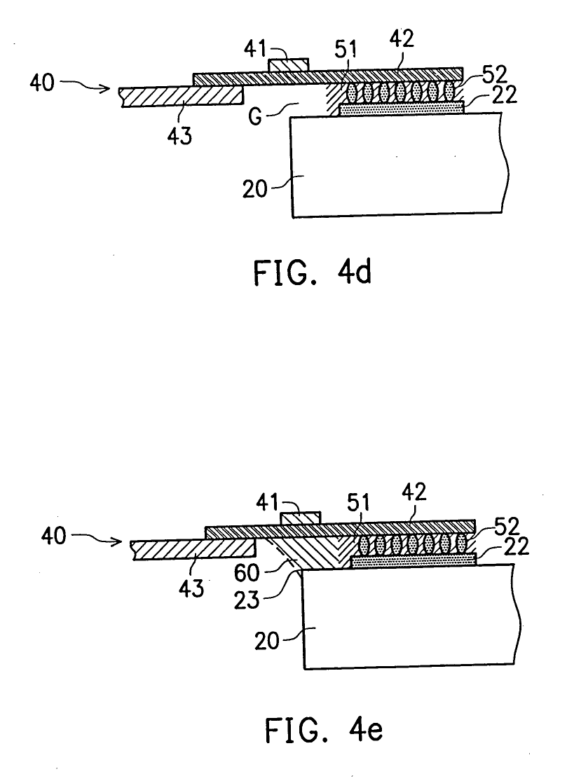

Referring to FIG. 4a, FIG. 4b, FIG. 4c, FIG. 4d and FIG. 4e, a method for bonding an integrated circuit device to a glass substrate, of a second embodiment of this invention comprises the following steps. First, a glass substrate 20 and an integrated circuit device 40 are provided. After the glass substrate 20 is scribed and broken, as shown in step S21 of FIG. 4a, one portion (the connecting wire 42) of the integrated circuit device 40 is bonded to a predetermined portion (the protecting circuit 22 disposed on the glass substrate 20) of the glass substrate 20 so that a gap G is formed between the other portion of the integrated circuit device 40 and the glass substrate 20, as shown in FIG. 4b and FIG. 4d and step S22 of FIG. 4a. Then, resin 60 is filled into the gap G so that the resin 60 covers the predetermined portion (edge 23) of the glass substrate 20, as shown in FIG. 4c and FIG. 4e and step S23 of FIG. 4a.

The resin 60 is cured by ultraviolet light. The connecting wire 42 is not in contact with the edge 23 of the glass substrate 20 due to the resin 60 when the integrated circuit device 40 is bonded to the glass substrate 20. Thus, there is no damage generated on the integrated circuit device 40.

In this embodiment, since the edge of the glass substrate is covered by the resin, no grinding process is required. Thus, there is no debris and dust produced and no post-bonding process is required to prevent vapors diffusing into the substrate. As a result, the whole process time is reduced, and throughput is enhanced.

While the invention has been particularly shown and described with reference to a preferred embodiment, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. A method for bonding an integrated circuit device to a glass substrate comprising:
placing a protecting circuit, connecting with an external circuit, on the glass substrate;
providing a melting device with a first laser device and a second laser device;
melting a predetermined portion of the protecting circuit by the first laser device emitting laser light with short wavelength, and then melting a predetermined portion of the glass substrate by the second laser device emitting laser light with long wavelength; and
bonding the integrated circuit device on the glass substrate.

2. The method as claimed in claim 1, wherein the integrated circuit device comprises a driver circuit, a connecting wire, and a main substrate, and the connecting wire is in contact with the predetermined portion, melted by the melting device, of the glass substrate when the integrated circuit device is bonded to the glass substrate.

3. The method as claimed in claim 2, wherein the connecting wire is bonded to the protecting circuit of the glass substrate via an adhesive and a plurality of conductive particles.

4. The method as claimed in claim 1, wherein the predetermined portion of the glass substrate is located at edges of the glass substrate.
